(19) United States
(12) Patent Application Publication
(10) Pub. No.: US 2019/0309503 A1
(43) Pub. Date: Oct. 10, 2019

(54) Device and Method for Cycling Liquid Contents of a Drum

(71) Applicant: Caleb F. Tucker, South Jordan, UT (US)

(72) Inventor: Caleb F. Tucker, South Jordan, UT (US)

(21) Appl. No.: 15/948,159

(22) Filed: Apr. 9, 2018

(51) Int. Cl. E03B 11/02; F16L 15/00; F16L 19/02

(52) U.S. Cl. CPC E03B 11/02; F16L 19/02; F16L 15/006

(57) ABSTRACT

A system for controlling refreshing of contents of a liquid container, e.g. a barrel, having an inlet component with a body, a horizontal conduit, and a vertical conduit, for connecting to a fresh liquid supply hose, including a pressure reducer in the first body component, and a barrel bunghole attachment means, such that, when installed in a barrel bunghole, pressurized fluid received from a fresh liquid supply hose is conducted through the horizontal conduit to the vertical conduit, through the pressure reducer and is directed towards an interior volume of liquid container to force contents in the liquid container out of an outlet bunghole. Optionally, the system includes an outlet component also having a body, a vertical conduit and a horizontal conduit with a connection means to a drain hose is provided, wherein fluid resistance of the outlet component is less than that of the pressure reducer.

### FIELD OF THE INVENTION

The invention generally relates to liquid storage devices and methods, and especially to a method for cycling and refreshing water stored long-term in a drum for emergency usage.

### BACKGROUND OF INVENTION

Plastic polyethylene plastic drums are well-known bulk containers designed to economically store and transport liquids. They are commonly used by households to store a secondary water supply in the event the primary water supply, such as city tap or well water, becomes contaminated or otherwise unavailable, such as during a storm, flood, or power loss. During an emergency scenario, households, businesses and organizations may turn to these water storage vessels to supply the primary source of potable water.

### SUMMARY OF THE DISCLOSURE

A system is disclosed for controlling refreshing of contents of a liquid container, such as water in a barrel, having at least an inlet component with a first body, a first horizontal conduit, and a first vertical conduit, for connecting to a fresh liquid supply hose, including a pressure reducer in the first body component, and a first barrel bunghole attachment means, such that, when installed in a barrel bunghole, pressurized fluid received from a fresh liquid supply hose is conducted through the first horizontal conduit to the first vertical conduit, through the pressure reducer and is directed towards an interior volume of liquid container to force contents in the liquid container out of an outlet bunghole. Optionally, an outlet component having a second body, a second vertical conduit and a second horizontal conduit with a connection means to a drain hose is provided, wherein fluid resistance of the outlet component is less than that of the pressure reducer.

### BRIEF DESCRIPTION OF THE DRAWINGS

The description set forth herein is illustrated by the several drawings.

FIG. 1 illustrates an embodiment according to the invention having two components, one for inlet flow processing and the other for handling of the outlet flow.

FIG. 2 provides a partial cutaway view of the body portions, without horizontal, vertical or elbow portions, of both inlet and outlet components of an embodiment such as that in FIG. 1.

FIG. 3 depicts a typical installation of a system according to the invention.

FIG. 4 shows a method of use of the present invention including fluid movement for cycling the contents of a barrel.

### DETAILED DESCRIPTION OF EMBODIMENT(S) OF THE INVENTION

The inventor of the present invention has recognized a problem not yet recognized and/or solved by those skilled in the relevant arts. Prolonged storage of water in polyethylene plastic drums for extended periods of time, without periodic cleaning, may lead to the development of bacteria or algae. If the water is being stored for the purposes of direct usage in the future, without processing or reprocessing (filtration, sterilization, etc.), then use of contaminated water presents a serious health hazard, especially in an emergency situation.

To avoid the health risk during an emergency one should perform regular maintenance on the drum to keep the water supply fresh and clean. However, regular cleaning of drums is a challenge, due to their size and weight, which is likely why many users fail to do it. Because full drums weigh nearly 500 pounds, attempting to move a full drum without emptying it first is a dangerous task. Therefore, it typically needs to be emptied at its storage location, which implies a need for a nearby drain, a pump to drive the water to a further destination, or both.

Drums stored in a garage or a basement tend to be far from a drain to which the contents of the drum can be discharged, and may be physically encumbered by other items stored in the area. The cleaning process includes siphoning the water out of the drum to empty it, removing the drum to an outside location, hosing it down, treating it with a cleaner such as a bleach solution, rinsing it thoroughly to remove all residues and traces of the cleaner, and returning it to its storage location to be refilled with fresh water. This process is labor intensive and consumes hours of time.

Because of these issues, there is on-going discussion among users of emergency water storage drums regarding methods to “cycle” (“flush”) water in a drum to refresh it without the steps of emptying, moving, cleaning, returning, and refilling. There are various challenges and limitations to accomplish this method which include:
(a) Using the methods proposed in popular discussions, pressure may accumulate in a drum during the cycling process. Drums are not intended to be pressure vessels, so pressure can cause a breach and flooding of the storage area.
(b) Vertical entry of hose connections to the drum causes kinks in the typical hose due to the weight of water in the hose. A kink in the exhaust hose may cause over-pressurization of the drum, breach of the drum wall, and flooding.
(c) Drum closures do not connect to readily-available “garden hoses” without additional plumbing parts. One would need to buy new drum caps and adapters to join a hose to the cap for cycling.

The present inventor, in view of these observations and recognitions of unsolved problems in the art, has realized that there is a need in the art for a fastening device or system that tightens aftermarket parts to the drum with enough torque to prevent leaks. The solution should allow for stationary cleaning and cycling of water in a drum which eliminates the need for the user to physically move the drum or physically remove the water for cleaning. Stationary cleaning greatly reduces the labor required to complete the task. The use of chemical disinfection in combination with cycling is a very effective and easy way to clean a drum. Chemical disinfection cleans the drum, and cycling using an embodiment of the present invention dilutes the disinfection chemical to safe levels for potable use.

The improved water cycling drum system (“cycler”) disclosed herein fastens to the drum and to readily-available hoses in order to deliver clean water to the drum and to carry old water out of it. The drum cycler system connects to a common hose thread for delivery of new water and also has a second connection which serves to expel the old water. This thread type is preferably compatible with garden hoses, recreational vehicle (RV) and marine hoses, washing machine hoses, or any hose with a common ¾″ hose thread.

The cycler is fastened to the drum with a drum wrench. At least one embodiment employs a slot design element that interlocks with the male edge of a plastic bung wrench. The cycler has a slot across the top, offset from the center, which serves as the female component to the male edge of a common plastic drum wrench. This becomes part of an interlocking mechanism to tighten the drum cycler to the drum.

Inlet and outlet hoses connect to the drum cycler horizontally instead of vertically. A lateral connecting feature greatly reduces the risk of a hose kinking under its own weight and unintentionally over-pressurizing the drum. Further, the cycler has a pressure reducing feature which greatly reduces the internal pressure of the drum during cycling operation. The fine-threaded cycler (inlet) has a smaller diameter port thru which water ingresses and restricts the flow of water into the drum, in this exemplary embodiment. The coarse thread cycler component (outlet) has a large diameter port through which the water egresses which promotes a low-pressure free-flow of liquid out of the drum, in this embodiment. The combination of restricting flow upon the ingress of liquid and promoting greater flow upon the egress greatly reduces the pressure inside the drum during the cycling process. In other embodiments, the inlet component may have the coarse thread, and the outlet component may have the fine thread, but in this embodiment, the pressure reducer should be located in the input component to protect the barrel from over-pressurization.

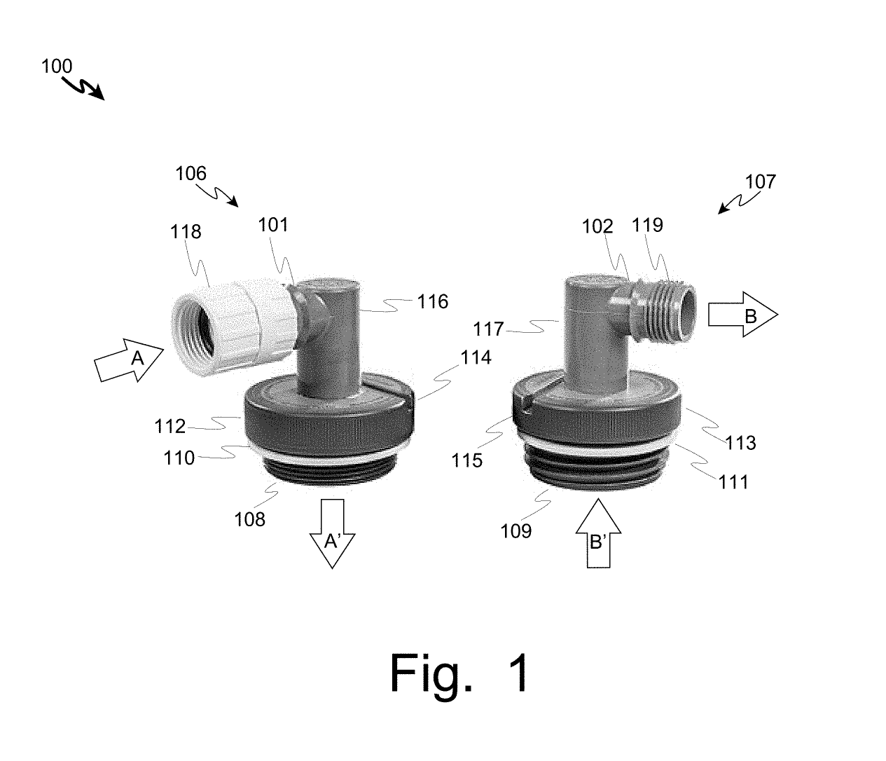

Turning now to FIG. 1, a system (100) of two components (106, 107) is shown in an embodiment according to the present invention. The first of the two components (106) is an inlet connector device for a first bunghole of a typical water storage barrel, and the second component (107) is an outlet connector device for the second bunghole of a typical storage barrel. Most common drums have a finer thread on one bunghole than on the other bunghole, so one component should match the finer thread and the other component should match the coarser thread. As shown in FIG. 1 in this embodiment, the inlet component (106) has the relatively finer threads (108), and the outlet component (107) has the relatively coarser threads (109). In other embodiments, this thread choice can be swapped, or alternative means of attachment of the components to the barrel head can be employed. In this embodiment, each grip portion (112, 115) of the components (106, 107, respectively) is preferably about 0.6 inch in height, about 2.87 in outer diameter, and provided with knurling or grooves to facilitate tightening and loosening by hand. Also in this embodiment, each component's (106, 107) threaded portion (108, 109, respectively) is sized to be received into and engaged by a threaded bunghole in a barrel head, wherein the finer thread is a standard 2″ National Pipe Straight (NPS), and the coarser thread is a standard 2.53″×0.1875″ buttress thread on a 2.5 inch core. Other thread types, twist-lock, quick release, and sizes may be used in other embodiments, of course.

Continuing to refer to FIG. 1, the inlet and outlet components (106, 107) are preferably provided with a washer or gasket (110, 111, respectively) to provide a water-tight seal when the threads are fully received and engaged into the bungholes of the barrel head. The inlet component (106) is preferably provided with a female garden hose connection (118), which conveys fresh water (arrow A) received from a supply garden hose and into a first horizontal conduit (101), through a right angle and into a first vertical conduit (116), and into the barrel interior cavity (arrow A′). The outlet component (107) is preferably provided with a male garden hose connection (119), which conveys stale water (arrow B′) from inside the barrel interior cavity, into a second vertical conduit (117), through a right angle, into a second horizontal conduit (102), and outward (arrow B′) to an exhaust or drain garden hose. The horizontal conduits ensure that the supply and exhaust hoses are pointed in a horizontal direction to prevent crimping or kinking under their own weight during operation. In other embodiments, other hose connections for other types of hoses may be employed, and the transition from the horizontal conduits to the vertical conduit may be elbows or other suitable conduit structures.

Still referring to FIG. 1, a preferred embodiment of the components includes grooves (114, 115) of approximately 0.18″ width and 0.25″ depth formed across the top of the components to receive an edge of a multipurpose wrench which is commonly used to remove or install the typical plugs or caps used on such storage drums. In other embodiments, this may be omitted, substituted or supplemented by other tool engagement recesses and/or protrusions, such as socket boss receivers, socket bosses, etc.

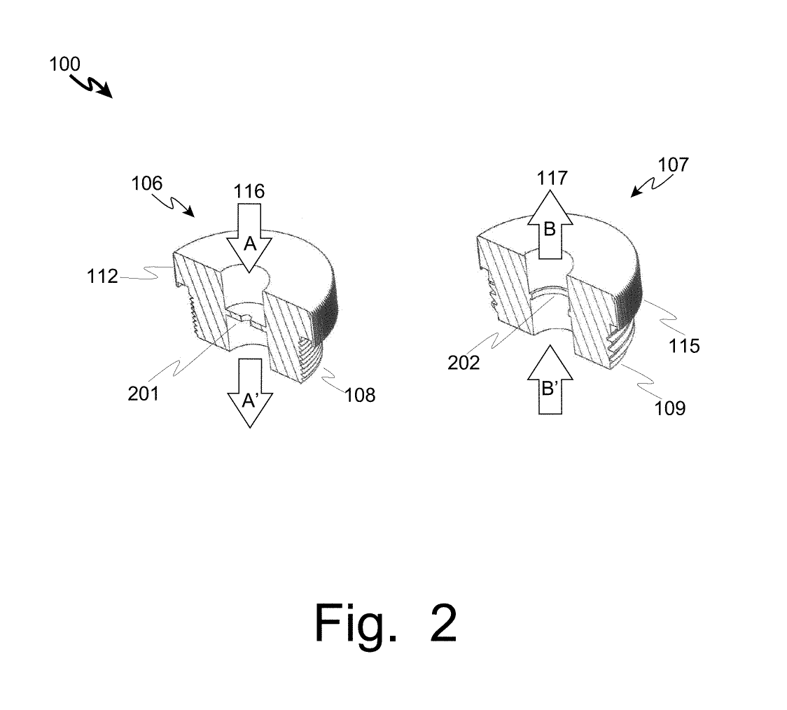

Turning to FIG. 2, a cutaway view of half of each of the components (106, 107) is shown to reveal an interior feature of each component. In the inlet component (106), a pressure reducer or limiter (201) is provided or formed, such as a disc with a hole of smaller diameter than the inside diameter of the first vertical conduit (not shown) through which fresh water is received (arrow A). In the outlet component (107), a throat opening (202) is larger than the hole (201) in the inlet component, thereby creating a lower fluid flow resistance at the outlet (arrow B) than at the inlet (arrow A). This feature provides at least two functions, the first of which is to accelerate the incoming fresh water to cause some agitation of the stale water inside the barrel, and the second of which is to ensure that the contents of the barrel are not over pressurized to avoid rupturing the barrel. In other embodiments, different pressure differential structures may be employed.

The components (106, 107) may be manufactured using a variety of approaches and a variety of materials, such as but not limited to Computer Numerical Control (CNC) machining, injection molding, welding or gluing of sub-components, or a combination thereof. Suitable materials include any pressure-capable, and preferably potable water compatible metal or plastic, such as copper, brass, aluminum, CPVC, PVC Schedule 80, PVC Schedule 40, high density polyethylene plastic (HDPE), and ABS plastic.

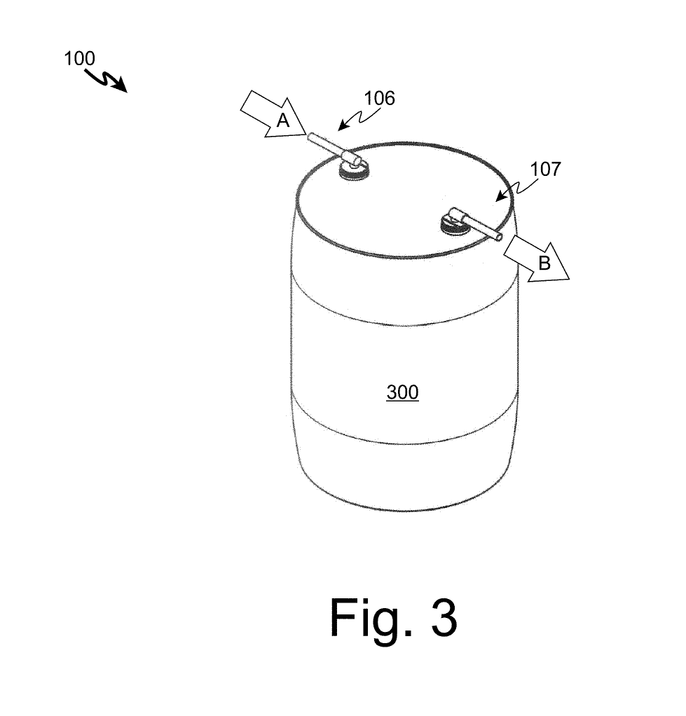

Turning now to FIG. 3, a perspective view of a manner of installing at least one drum contents cycling system (100) on a barrel (300) is shown, with one component configured to receive fresh water (arrow A), and the other component configured to exhaust stale or mixed stale-fresh water (arrow B). After removing any existing caps or plugs in the bungholes of the barrel, each component is threaded into its compatibly-threaded bunghole, as shown.

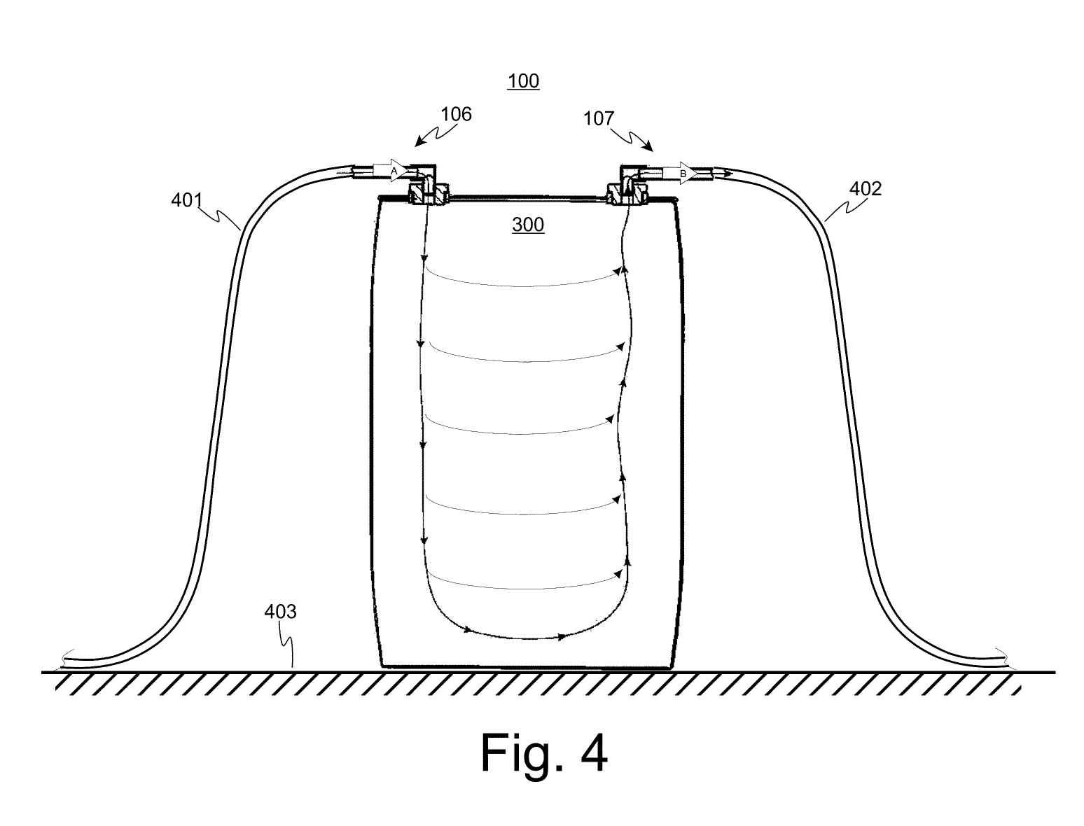

Referring now to FIG. 4, a manner of usage of the system (100) on a barrel (300) storing water within its interior volume is shown, wherein the barrel in this example is resting on a surface (403), such as the ground or a shelf or support. The barrel is oriented in a head-up position such that the bungholes are above the rest of the barrel. The fresh water hose (401) is connected to the inlet component (106), and the exhaust or drain hose (402) is connected to the outlet component (107). Depending on the size of the hoses (401, 402), the pressure of the fresh water (arrow A) source, the volume of the barrel, and the size of the internal pressure limiter or flow restrictor in the inlet component (106), and potentially the time since the last refreshing cycle, the barrel contents can be refreshed by turning on the supply of water and letting it exhaust at the outlet for a few minutes to several hours. Additionally, enhanced processes may include adding a small quantity of bleach or other sanitizer for a period of time prior to starting the refreshing cycle.

In some embodiments, a down tube extending from the inlet component down towards the bottom of the barrel was provided to the system. It was believed that this earlier embodiment would enhance the fluid exchange during cycling operation. However, after feedback from users and distributors, it was determined that the benefit of this component was negligible. An improved design disclosed herein omits a downtube on either the inlet component or outlet component, thereby reducing the shipping costs and storage requirements for the system, while maintaining all of the beneficial operations.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A system for controlling refreshing of contents of a liquid container comprising:
an inlet component having a first body;
a first horizontal conduit in fluid communication to a first vertical conduit, wherein the first horizontal conduit is configured to connect to a fresh liquid supply hose, and wherein the first vertical conduit is in fluid communication through the first body;
a pressure reducer disposed in the first body; and
a first bunghole attachment means mechanically affixed to the first body, such that fluid received from a fresh liquid supply hose is conducted through the first horizontal conduit to the first vertical component, through the pressure reducer and is directed towards an interior volume of liquid container to force contents in the liquid container out of an outlet bunghole, wherein the inlet component avoids structure which extends into the interior volume of the liquid container.

2. The system as set forth in claim 1 wherein the configuration to connect to a fresh liquid supply hose comprises a garden hose connection.

3. The system as set forth in claim 2 wherein the garden hose connection comprises a female threaded connection.

4. The system as set forth in claim 2 wherein the garden hose connection comprises a male threaded connection.

5. The system as set forth in claim 1 wherein the first bunghole attachment means comprises a two-inch national pipe straight (NPS).

6. The system as set forth in claim 1 wherein the first bunghole attachment means comprises a standard 2.53″×0.1875″ buttress thread on a 2.5 inch core.

7. The system as set forth in claim 1 further comprising:
an outlet component having a second body;
a second vertical conduit in fluid communication through the second body, and a second horizontal conduit in fluid communication with the second vertical conduit, wherein the second horizontal conduit is configured to connect to an liquid drain hose, and wherein a fluid communication path through the second body to the second vertical conduit to the second horizontal conduit presents less fluid flow resistance than resistance of the pressure reducer; and
a second bunghole attachment means mechanically affixed to the second body, such that fluid pressured from within a liquid container is conducted through the second vertical conduit to the second horizontal conduit to a connected liquid drain hose.

8. The system as set forth in claim 7 wherein the configuration to connect to a liquid drain hose comprises a garden hose connection.

9. The system as set forth in claim 8 wherein the garden hose connection comprises a female threaded connection.

10. The system as set forth in claim 8 wherein the garden hose connection comprises a male threaded connection.

11. The system as set forth in claim 7 wherein the second bunghole attachment means comprises a two-inch national pipe straight (NPS).

12. The system as set forth in claim 7 wherein the second bunghole attachment means comprises a standard 2.53″×0.1875″ buttress thread on a 2.5 inch core.

13. The system as set forth in 1 wherein the body further comprises a knurling disposed around a periphery of the body.

14. The system as set forth in 7 wherein the body further comprises a knurling disposed around a periphery of the body.

15. The system as set forth in 1 wherein the body further comprises a slot for engaging a leveraging tool.

16. The system as set forth in 7 wherein the body further comprises a slot for engaging a leveraging tool.
